(19) United States
(12) Patent Application Publication
(10) Pub. No.: US 2011/0165903 A1
(43) Pub. Date: Jul. 7, 2011

(54) Coordinated Transmission for Secondary Usage

(75) Inventors: Yngve Selen, Uppsala (SE); Olav Queseth, Solna (SE); Joachim Sachs, Aachen (DE); Jonas Kronander, Uppsala (SE)

(73) Assignee: TELEFONAKTIEBOLAGET LM ERICSSON (PUBL), Stockholm (SE)

(21) Appl. No.: 13/061,969

(22) PCT Filed: Sep. 5, 2008
(86) PCT No.: PCT/SE2008/050996

§ 371 Date: Mar. 3, 2011

(51) Int. Cl. H04W 72/04

(52) U.S. Cl. 455/509

(57) ABSTRACT

The present invention relates to a method and a secondary user enabling secondary usage of radio resources owned by a primary party. The present invention also relates to a primary party and a broker. The secondary user is adapted to obtain radio resource allocation information transmitted from the primary party. It is further adapted to identify radio resources available for secondary usage based upon the radio resource allocation information. It is finally adapted to engage in communication over at least part of the radio resources identified as available for secondary usage.

### TECHNICAL FIELD

The present invention relates to a method and a secondary user enabling secondary usage of radio resources owned by a primary party. The present invention also relates to a primary party and a broker.

### BACKGROUND

The usage of radio spectrum is being liberalized in that frequency bands are not exclusively assigned to a particular transmission system any more. This is largely based on the observation that spectrum assigned by licenses to licensees is often not used. One approach pursued in regulations is to license the spectrum to a licensee (primary party), while at the same time the frequency band can be used by other users (secondary users) under the condition that they do not interfere with the system operation of the primary party.

This approach is being applied in the US for the TV bands (54 MHz to 806 MHz); a new standard is being developed in IEEE 802.22 to provide wide-area regional wireless communications in these bands on a secondary basis. The 802.22 standard applies “cognitive radio” methods, meaning that the secondary user autonomously detects if it interferes with a primary parties and withdraws in these cases.

IEEE 802.22 is a new working group which aims at constructing Wireless Regional Area Network (WRAN) utilizing unused channels (white spaces) in the allocated TV frequency spectrum. 802.22 specify that the network should operate in a point to multipoint (P2MP) manner. The system is formed by base stations and wireless end devices. The base stations are capable of performing distributed sensing. This means that the devices will sense the TV spectrum and send reports to the station. The base station will then evaluate whether the channel can be used or if it has to change channel.

In cognitive radio applied in IEEE 802.22 either a network or a wireless node of the primary party has to change its transmission or reception parameters to communicate efficiently and avoid interfering with licensed or unlicensed users. Cognitive radio comprises a function called spectrum sensing where the channels not used by the primary party are detected and shared by secondary users without causing unduly interference. The spectrum is consequently being monitored in order to find available spectrum. The spectrum can for instance be sensed by transmitter detection, meaning detection where there is a signal from the primary party in a particular spectrum.

The problem of 802.22 is that the cognitive radio approach introduces significant overhead. One reason is that the 802.22 system has to determine by measurements if a primary party is active in the relevant bands. Moreover, it has to control the wireless end devices for making appropriate distributed sensing. Furthermore, it has to estimate if secondary usage of the spectrum interferes with primary transmission.

Another problem is that the 802.22 system has to determine available transmission resources with sufficient guard distance/band to primary transmission. Moreover it has to detect if a primary party intends to use the spectrum resource again. Furthermore, it has to be able to withdraw and reallocate resource usage. Finally, it has to perform all of the above activities repeatedly

A chirped RADAR system is another example of a primary party. In such systems the RADAR sends out a signal (such as a sine wave) which sweeps the entire allocated spectrum. FIGS. 9-10 shows an example of a chirp signal (sine wave). In FIG. 9 the frequency over time is shown and in FIG. 10 the actual sine wave over time is shown. Such a signal is difficult to detect with traditional detection-based sensing techniques, because each sub-band of the spectrum is only occupied during a very short time period. Furthermore, whenever the RADAR is operational it needs access to its entire spectrum in order not to suffer from poor performance.

As can be seen by the above examples, secondary spectrum access based on cognitive functionality (e.g. primary transmission detection) is complicated. Systems without primary transmission detection functionality, such as LTE, UMB and WiMAX, are not able to allow secondary usage.

### SUMMARY

The object of the present invention is therefore to improve the sharing of radio resources for enabling a secondary usage of the available resources.

This is solved by means of a method for enabling secondary usage of radio resources owned by a primary party. The method comprises a step of obtaining radio resource allocation information transmitted from the primary party. It further comprises a step of identifying radio resources available for secondary usage based upon the radio resource allocation information. It finally comprises a step of engaging in communication over at least part of the radio resources identified as available for secondary usage.

The object is also solved by means of a secondary user adapted for enabling secondary usage of radio resources owned by a primary party. The secondary user is adapted to obtain radio resource allocation information transmitted from the primary party. It is further adapted to identify radio resources available for secondary usage based upon the radio resource allocation information. It is finally adapted to engage in communication over at least part of the radio resources identified as available for secondary usage.

The object of the present invention is also solved by means of a primary party being adapted to coordinate or negotiate about the radio resources available for secondary usage with a secondary user according to any of the claims 15-25.

The object is finally solved by means of a broker being adapted to coordinate or negotiate about the radio resources available for secondary usage with a secondary user according to any of the claims 15-25 and a primary party according to any of the claims 26-29.

The present invention allows secondary usage in the frequency bands, such as TV frequency bands. TV frequency bands are appropriate for secondary usage for several reasons. One is that the TV bands have large spectrum capacity which is only partly used for TV and therefore can be utilized for secondary usage. Moreover, the TV bands have favourable propagation conditions, which mean that secondary usage can be cost effective. There is a large potential to open up other frequency bands for mobile communication systems. The present invention provides a solution to achieve this. The invention further allows secondary usage in frequency bands used by RADAR systems or fixed satellite systems and other types of systems as well.

### BRIEF DESCRIPTION OF DRAWINGS

In the following text the invention will be described in detail with reference to the attached drawings. These drawings are used for illustration only and do not in any way limit the scope of the invention:

FIG. 1 shows an overlay of a primary party and a secondary user.

FIG. 2 shows radio resources allocated by the primary party and available radio resources.

FIG. 3 shows a secondary base station with an S1 receiver.

FIG. 4 shows a secondary base station with a communication link to the primary party.

FIG. 5 shows a radio resource grid of the secondary user.

FIG. 6 shows a secondary usage of available radio resources by the secondary user.

FIG. 7 shows coordination and negotiation of resource usage between the primary party and the secondary user.

FIG. 8 shows coordinated radio resource usage by primary party for improving secondary usage.

FIG. 9 shows an example of a chirped channel (sine wave), where the frequency over time is shown.

FIG. 10 shows an example of a chirped channel (sine wave), where the actual sine wave over time is shown.

FIG. 11 shows a flow chart of the method for enabling a secondary usage of radio resources.

### DETAILED DESCRIPTION

The invention will now be described in detail with reference to embodiments described in the detailed description and shown in the drawings. The embodiments of the invention with further developments described in the following are to be regarded only as examples and are in no way to limit the scope of the protection provided by the patent claims.

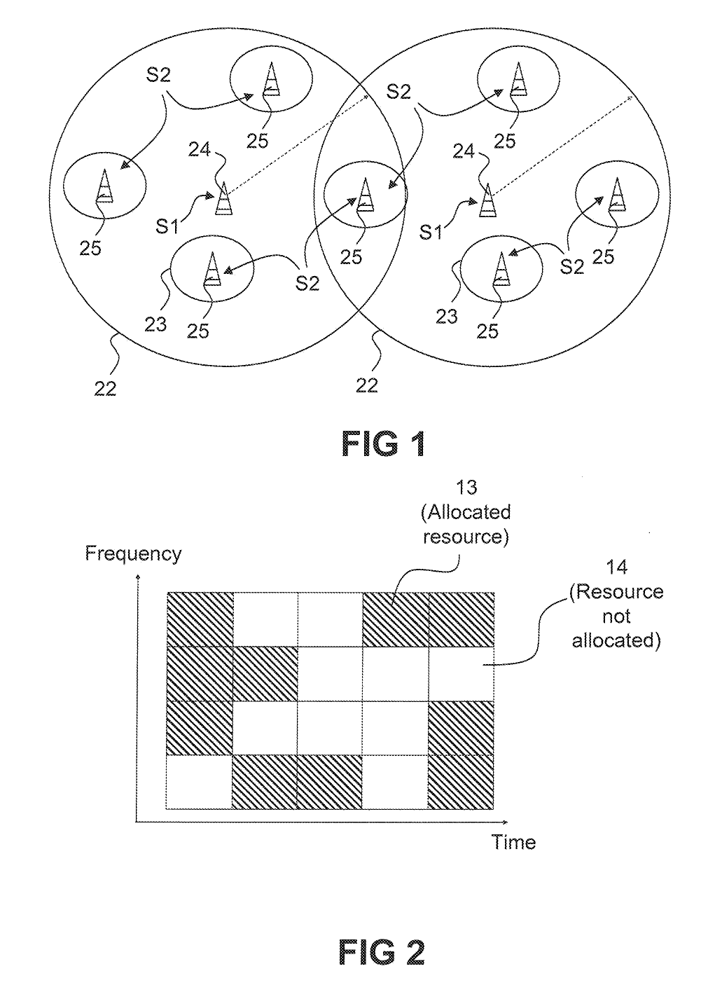

FIG. 1 shows an overlay of a primary party S1 with two base stations 24 and a secondary user S2 with a plurality of base stations 25. A primary party is a license holder to a frequency band and has the right to not be disturbed by secondary users. It is an entity which has legal right to use a frequency band. Such a band could for instance be TV frequency band. It could as an alternative be a RADAR band, a band used by fixed satellite systems, or any other frequency band. Examples of secondary users are Long Term Evolution (LTE) systems, Ultra Mobile Broadband (UMB) and WiMAX. The secondary user will in the following be exemplified by a secondary system.

By the present invention, the primary party S1 can make a secondary system S2 aware of which part of its (i.e. S1) frequency band it is using and/or which part that is not used. In general, the invention can be applied to any combination of primary party/secondary systems based on all different kinds of radio access technologies and wireless standards.

FIG. 1 illustrates the coverage of each primary party cell 22 and each secondary system cell 23. If the primary party frequency band has favourable propagation conditions, a secondary system S2 can benefit from the large coverage when using the available radio resources in this frequency band in a secondary usage. This result in that coverage of the secondary system's cells 23 can be increased, maybe even to the size of the primary party cells 22.

The method according to the present invention is aimed for enabling secondary usage of radio resources owned by a primary party S1. The radio resources owned by the primary party are in the frequency band/-s for which the primary party holds the license. Secondary usage means usage of radio resources by systems S2 other than the primary party S1, the other systems exemplified by the secondary system.

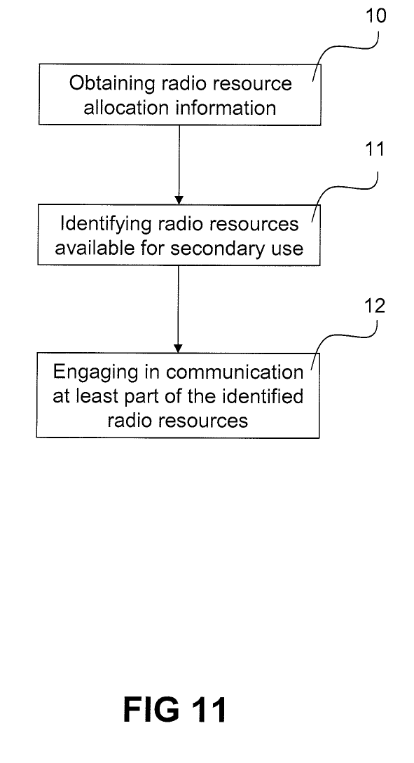

In order to enable such a secondary usage the method comprises the steps of (see FIG. 11):
1. Obtaining 10 radio resource allocation information transmitted from the primary party.
2. Identifying 11 radio resources available for secondary usage based upon the radio resource allocation information.
3. Engaging 12 in communication over at least part of the radio resources identified as available for secondary usage.

These steps 10, 11, 12 are performed by one or more units or entities in the secondary system S2. The basic idea of the invention is consequently to obtain information in at least one secondary system S2 about the resource usage by the primary party S1 and to make secondary usage by the secondary system or systems of the available radio resources.

FIG. 2 shows radio resources 13 allocated by the primary party S1 and available 14 radio resources. Radio resource allocation information is information about the primary party's usage of the radio resources. This information may comprise either the allocation 13 of the radio resources by the primary party S1 or the resources not allocated (available resources) 14 by the primary party, or both. Also information related to the usage of guard bands 15 (see below) and other types of information can be included in the radio resource allocation information.

Secondary usage means that resources 14 not occupied by the primary party may be used by secondary systems. Radio resources could for instance be time, frequency, power, code, geographic location and spatial location. All these resources are dealt with in the invention.

The radio resource allocation information could be obtained directly from the primary party or via a third entity. If a third entity is involved, it could have a passive role of only storing and forwarding the information, or an active role (will be described later) in the distribution of radio resources. The secondary systems engage in communication over the available resources, or at least over parts of them. If more than one secondary system is involved, they have to share the available radio resources.

According to this invention a base station 25 of the secondary system S2 obtains explicit radio resource allocation information by the primary party S1. This information can be obtained in two ways. According to one embodiment the secondary system obtains the radio resource allocation information via a control channel or control channels from one or a plurality of primary party transmitter(s), the channel or channels specify the allocation of radio resources by the primary party.

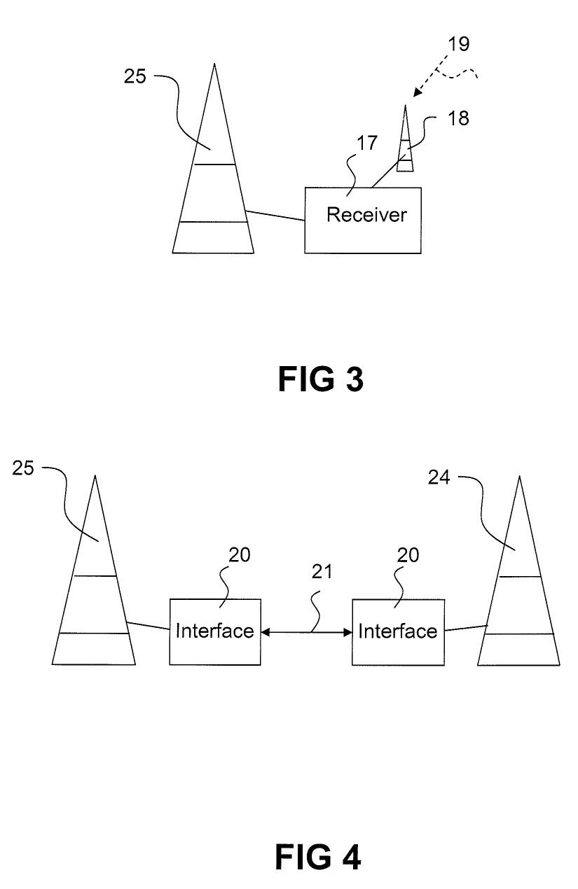

The base station 25 of the secondary system S2 contains an S1 receiver 17, see FIG. 3, for the control channel(s) of the signals transmitted by the primary party S1 on a particular frequency band. As a user it receives S1 control channel messages 19 containing the radio resource allocation information. This radio resource allocation information obtained via the S1 receiver can be denoted “channel-allocation maps”, and it provides the base station 25 of the secondary system S2 with sufficient information so that it can identify 11 radio resources available for secondary usage. This is made by determining what S1 information channel it should decode if it wants to receive a certain data stream (e.g. TV channel).

From this channel allocation map the S2 base station 25 can determine resources unused by the primary party S1 and this information can be processed in a resource management function of the S2 base station. The S2 base station can then determine suitable secondary transmission in unused white spaces 14 (resources not allocated), see FIG. 2. With this approach the primary party S1 does not need to be aware of the secondary system S2, since it only listens to primary parties control channel information and the primary party is not aware of the secondary system.

The secondary system S2 may also obtain the radio resource allocation information via a communication link. The communication link is for instance a fiber or an over-the-air communication. If a communication link is used, the radio resource allocation information could be obtained via one-way signalling. This means that the secondary system only listens to primary party's S1 information via the link and the primary party S1 is not aware of the secondary system. However, radio resource allocation information transmitted by the primary party S1 is intended for secondary systems S2. In this manner, any secondary systems will know which radio resources are available and which resources must be avoided. An example of such an embodiment is a chirped RADAR system, where the RADAR can signal with only a single bit of information whether its frequency band is occupied or not.

In another embodiment, the communication link 21, see FIG. 4, is used for two-way signalling. This means that the primary party S1 is at least aware of the secondary system. The secondary system's S2 base station 25 can have a direct interface 20 to the primary party S1 base station 24. This is for instance enabled using radio links provided by S1 or by using other networks available to the systems.

In one embodiment, the primary party S1 via this interface 20 provides the secondary system S2 with information about the channel/resource allocation for the (near-term) future. The radio resource allocation information specifies the future allocation of radio resources by the primary party. This information could for instance have the form of specifying when the entire primary spectrum (licensed frequency band) of S1 will be available and when it will not. The S2 base station 25 can then determine suitable secondary transmission in unused white spaces (resources not allocated), see FIG. 2.

Once the secondary system S2 knows about primary resources not allocated 14 by the primary party, see FIG. 2, it has to determine the radio resources available 16, see FIG. 4, for secondary usage. This means that it has to determine if the secondary usage is reasonable and how it can be performed. In order to do so, the secondary system in a first step at least determines the available resources on the basis of an interference guard band 15. This is a guard frame between the primary party and the secondary system. With this guard, the primary party is not affected by the secondary usage, whose usage is feasible and not too much interfered by the primary party.

In order to avoid overlapping/interfering transmission the interference guard band 15 has to consider sufficient time separation (e.g. depending on delay spread of the channel and MAC procedures (e.g. contention periods) of the primary party and secondary system). Moreover, the amount of and precision of time synchronization between primary party/secondary system and frequency separation is considered.

The interference guard band further has to consider adjacent channel and filter requirements, as well as transmit power of primary and secondary system, to prevent interference from the secondary system to the primary party in the frequency or spatial domain.

When the interference guard band 15 is determined a second step is performed for identifying the radio resources 16 available for secondary usage (resources not allocated by the primary party) by the secondary system S2. In this step the secondary system S2 has to identify to what extent the radio resources 16 can be used for secondary transmission. This is done at least one the basis of the time and frequency resource structure of the secondary system. It is also done on the basis of the time and frequency size of the available resources 14 and the required interference guard band 15 and/or suitable transmission power.

As a result a number of secondary sub-carriers and time slots, together with their corresponding locations in the time-frequency space, can be determined for secondary transmission (see FIG. 6). As one option there can be a soft-boundary towards the primary party, e.g. by requiring secondary sub-carriers close to the primary allocations to use lower transmission power.

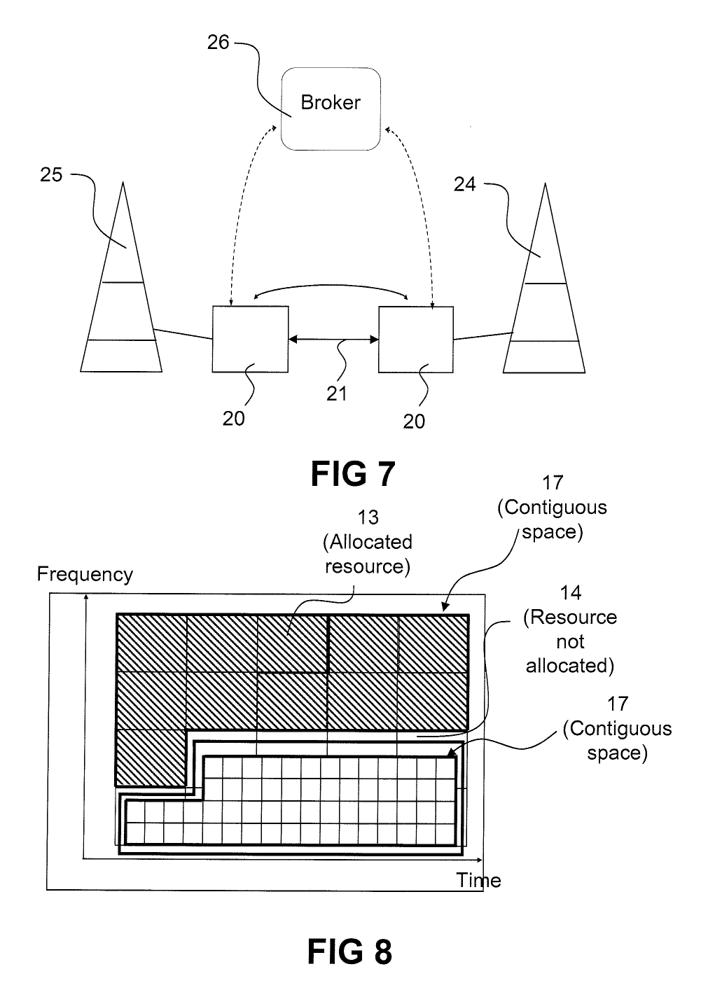

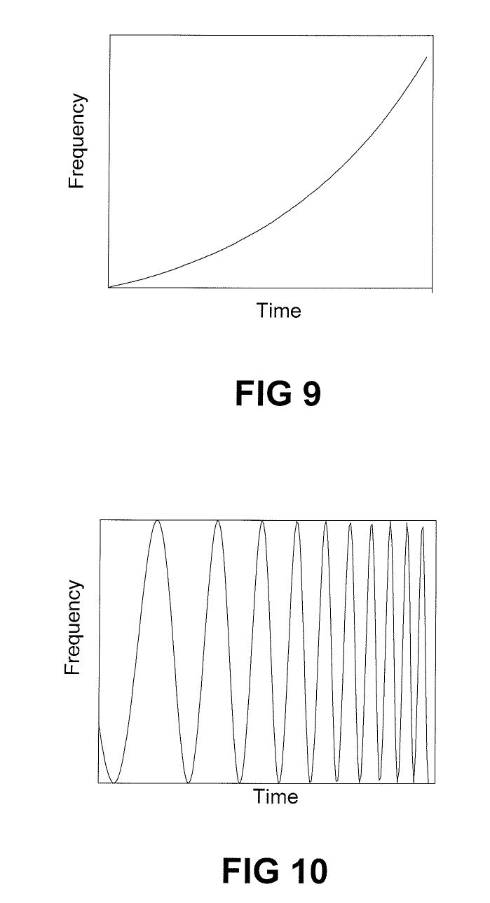

The method according to the present invention may further comprise a step of coordinating or negotiating about the radio resources available for secondary usage with the primary party S1. If there is more than one primary party transmitter, see FIG. 1, the secondary system S2 may coordinate the radio resources available with each primary party cell. A cooperative secondary usage scheme is indicated in FIG. 7. The primary party S1 and the secondary system S2 coordinate the usage of the frequency band. This can be done either directly between the primary party and the secondary system, via the communication link 21, described in relation to FIG. 4, or via an intermediate broker (see below).

The negotiation may comprise the step of requesting or bidding for resources (e.g. pricing of resources) via the communication link 21. This could be dealt with in the communication between the primary party S1 and the secondary system S2, which means that the primary party negotiates with the secondary system about the resources. As an alternative, the radio resources can be negotiated via an intermediate broker 26, whereas the dynamic coordination of resource usage is directed by the primary party and the secondary system. This approach requires a specific interface 20 between the primary party and the secondary system (which may also go via some broker function).

The invention is however not limited in this manner. Additional information such as pricing etc. can also be transmitted from S1 to S2. Via this mechanism S1 can lease its frequency band, e.g. to cellular operators, at temporal and/or spatial locations where it does not use the band itself.

The coordination may comprise a step of allocating the radio resources used by the primary party in such a way so that the radio resources 14 available are beneficial for secondary usage, see FIG. 8. For support of secondary usage, the primary party S1 performs resource allocation that result in large contiguous spaces 17. For example, the primary party limits itself to a reduced number of sub-carriers. In case that the primary party exploits frequency selectivity of the channel by dynamic time-frequency scheduling, the party may want to use enough sub-carriers to provide sufficient frequency diversity. The easiest way would be for the primary party to allocate transmission to contiguous resource blocks (leading also to contiguous spaces).

The allocation step could be such that the amount of radio resources contiguously available for the secondary usage is increased. Contiguous resources refer both to frequency and time domain.

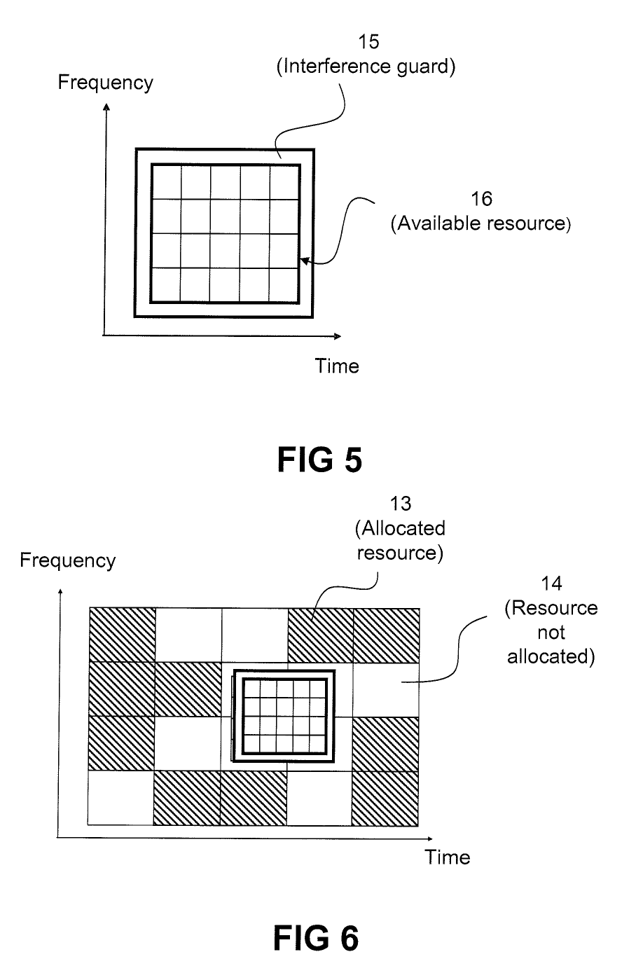

In a more advanced scheme, the primary party may also obtain information about the resource grid structure of the secondary system and required interference guard band 15 (see FIG. 5) and then schedule its own data such that the resulting spaces 17 fits the resource structure of the secondary system (e.g. free time-frequency space minus interference guard gives maximum number of secondary system resource blocks available to the secondary system).

The coordination and negotiation described optimizes the contiguous space 17 allocation for the secondary usage. In order to improve the secondary usage of the primary party resources the primary party can make use of the resources such that the remaining contiguous spaces are favourable for usage by a particular secondary system and that the secondary usage of available white spaces is maximised. Such behaviour can be economically motivated if there is a market for secondary resource usage; e.g. a primary party that does not make full use of the frequency band resources to which it has the primary usage rights can lease parts of the resources to secondary systems.

For a TV operator this may prove another income besides the traditional income of payment for advertisements, tax-supported funding, and payment by end users. For a secondary operator this may be a more economic option of expanding its capacity compared to licensing other frequency bands for primary usage. It is in particular useful for temporary capacity demand, e.g. during special events like Olympic Games.

The secondary system S2 could be one or more systems that want to use the available radio resources. In the case there is more than secondary system that want to use the available radio resources, these systems have to coordinate and negotiate as described earlier. For instance, the systems may enter a resource sharing scheme, or the sharing of resources can be controlled by the primary system (provided the necessary interface exist) or an intermediate broker via, e.g. bidding.

The primary party S1 could be one or more parties having license to at least one frequency band. If there are overlapping primary party cells 22 these could belong to the same or different parties. The secondary system S2 may then obtain the radio resource allocation information transmitted from at least one primary party S1 or primary party transmitter. It can be that one of the secondary system base stations S2 is located within a range of two or more primary party S1 cells 22, as shown in FIG. 1. This means that the secondary system has to determine which primary party or primary party cells that make use of the radio resources for the coverage area in which it desires to engage in secondary communication.

There may consequently be a method step where the secondary system S2 coordinates the radio resources available with each primary party S1 or primary party cell 22. It can be that a secondary system's S2 base station is located within a range of two or more primary party S1 cells, as shown in FIG. 1. This means that it has to coordinate with all those primary nodes.

The primary party transmitter may be located in the base station 24 in a TV broadcast system. However, it should be realized by a person skilled in the art that it could be any kind of transmitter, which means that the invention is not narrowed to TV broadcast systems. Such a transmitter is for instance a RADAR transmitter, another cellular communication system or a fixed satellite system.

1-22. (canceled)

23. A method implemented by a secondary system for engaging in secondary usage of radio resources that are primarily used by a primary system and that are owned by a primary party, the method comprises:
obtaining radio resource allocation information from at least one primary party transmitter associated with the primary system, either via one or more control channels transmitted by said primary party transmitter, or via a communication link with said primary party transmitter,
identifying radio resources available for secondary usage based upon an interference guard band and the radio resource allocation information, and
engaging in communication over at least part of the radio resources identified as available for secondary usage.

24. The method according to claim 23, wherein said identifying comprises identifying the radio resources available for secondary usage based on a time and frequency resource structure of the secondary system.

25. The method according to claim 23, wherein the radio resource allocation information is obtained via one-way signalling with the primary system.

26. The method according to claim 23, wherein said identifying comprises either:
coordinating with the primary party transmitter to determine which radio resources are available for secondary usage; or
negotiating with the primary party transmitter for radio resources for secondary usage.

27. The method according to claim 26, wherein said coordinating comprises also coordinating with other primary party transmitters associated with the primary system.

28. The method according to claim 26, wherein said negotiating comprises requesting or bidding for radio resources for secondary usage.

29. The method according to claim 26, wherein said negotiating comprises negotiating via an intermediate broker apparatus.

30. The method according to claim 26, wherein the radio resource allocation information specifies a future allocation of radio resources by the primary party transmitter.

31. A method implemented by a primary system for enabling secondary usage of radio resources by a secondary system, the radio resources primarily used by the primary system and owned by a primary party, the method comprising coordinating or negotiating with the secondary system to determine which radio resources are available for secondary usage, considering an interference guard band and radio resources allocated for primary use by the primary system.

32. The method according to claim 31, wherein said coordinating comprises allocating radio resources for primary use by the primary system to maximize the radio resources available for secondary usage by the secondary system.

33. The method according to claim 32, wherein said allocating comprises allocating radio resources for primary use by the primary system to maximize the contiguous radio resources available for secondary usage by the secondary system.

34. A secondary system configured to engage in secondary usage of radio resources that are primarily used by a primary system and that are owned by a primary party, wherein the secondary system is configured to:
obtain radio resource allocation information from at least one primary party transmitter associated with the primary system, either via one or more control channels transmitted by said primary party transmitter, or via a communication link with said primary party transmitter,
identify radio resources available for secondary usage based upon an interference guard band and the radio resource allocation information, and
engage in communication over at least part of the radio resources identified as available for secondary usage.

35. The secondary system according to claim 34 configured to identify the radio resources available for secondary usage based at least on a time and frequency resource structure of the secondary system.

36. The secondary system according to claim 34, configured to obtain the radio resource allocation information via one-way signalling with the primary system.

37. The secondary system according to claim 34, configured to either:
coordinate with the primary party transmitter to determine which radio resources are available for secondary usage; or
negotiate with the primary party transmitter for radio resources for secondary usage.

38. The secondary system according to claim 37, configured to coordinate by also coordinating with other primary party transmitters associated with the primary system.

39. The secondary system according to claim 37, configured to negotiate by requesting or bidding for radio resources for secondary usage.

40. The secondary system according claim 37, configured to negotiate via an intermediate broker apparatus.

41. The secondary system according to claim 34, wherein the secondary system comprises a base station, the base station including a receiver or an interface for obtaining the radio resource allocation information, and a resource management circuit for identifying the radio resources available for secondary usage.

42. A primary system for enabling secondary usage of radio resources by a secondary system, the radio resources primarily used by the primary system and owned by a primary party, the primary system configured to coordinate or negotiate with the secondary system to determine which radio resources are available for secondary usage, considering an interference guard band and radio resources allocated for primary use by the primary system.

43. The primary system according to claim 42 comprising at least one primary party transmitter configured to coordinate with the secondary system to determine the radio resources available for secondary usage.

44. The primary system according to claim 42, configured to negotiate via an intermediate broker apparatus.

45. The primary system according to claim 42, configured to coordinate by allocating radio resources for primary use by the primary system to maximize the radio resources available for secondary usage by the secondary system.

46. A broker apparatus serving as an intermediary between a primary system and a secondary system for enabling secondary usage of radio resources by a secondary system, the radio resources primarily used by the primary system and owned by a primary party, the broker apparatus configured to broker coordination or negotiation between the primary system and the secondary system for determining which radio resources are available for secondary usage by the secondary system, said coordination or negotiation considering an interference guard band and radio resources allocated for primary use by the primary system.
